(19) United States
(12) Patent Application Publication
(10) Pub. No.: US 2013/0256388 A1
(43) Pub. Date: Oct. 3, 2013

(54) METHOD OF FORMING A SOLID OXIDE TUBE COUPLED TO A CURRENT COLLECTOR

(71) Applicants: Shawou Zha, Ann Arbor, MI (US); Timothy LaBreche, Ann Arbor, MI (US)

(72) Inventors: Shawou Zha, Ann Arbor, MI (US); Timothy LaBreche, Ann Arbor, MI (US)

(73) Assignee: ADAPTIVE MATERIALS, INC., Ann Arbor, MI (US)

(21) Appl. No.: 12/494,422

(22) Filed: Jun. 30, 2009

(51) Int. Cl. H01M 8/02

(52) U.S. Cl. CPC H01M 8/0202
USPC 228/126; 429/482

(57) ABSTRACT

A method for forming a solid oxide fuel cell brazed to a current collector includes heating the solid oxide fuel cell, the current collector, and a primary brazing slurry above a brazing temperature and subsequently cooling the solid oxide fuel cell, the current collector and the primary brazing slurry below the brazing temperature. The method further includes heating the solid oxide fuel cell, the current collector and the secondary brazing slurry above the brazing temperature and subsequently cooling the solid oxide fuel cell primarily brazed to the current collector and the secondary brazing slurry below the brazing temperature.

### CLAIM OF PRIORITY

This application claims priority to Provisional Application No. 60/206,488 filed on Jan. 30, 2009.

### GOVERNMENT INTERESTS

This invention was made with government support under contract number W909MY-08-C-0025, awarded by the Department of Defense. The government has certain rights in this invention.

### FIELD OF THE DISCLOSURE

The disclosure relates to fuel cells and more particularly to current collectors for fuel cells.

### BACKGROUND

Fuel cells generate electromotive force at an electrolyte to force electrons to travel throughout an electric circuit. The fuel cell includes two electrodes disposed on opposite sides of the electrolyte. The fuel cell includes an electrode configured to catalyze a reducing reaction and an electrode configured to catalyze an oxidizing reaction. The energy conversion efficiency of the fuel cell is related to the efficiency at which the electrons are collected across electrodes and the rate at which electrons are transferred between the electrodes and other parts of the electric circuit. In addition to electrical conduction properties, the energy conversion efficiency of the fuel cell is also related to the pore structure of the electrode and the catalytic efficiency of the electrode. Therefore, optimizing energy conversion efficiency often requires optimizing competing properties of the fuel cell electrodes. For example, providing a pore structure having high surface area for fuel transfer to the electrolyte and high levels of catalytic surface area can result in an electrode having low electrical conductivity.

Electrode current collectors can increase the electrical conduction efficiency and the current transfer efficiency between the fuel cell electrode and other parts of the circuit powdered by the fuel cell. However, electrical conduction efficiency of electrode current collectors can significantly degrade when fuel cells are thermally cycled due to contraction or deformation of the electrode current collectors. Therefore, fuel cells with improved current collection are needed.

### SUMMARY

A method for forming a solid oxide fuel cell brazed to a current collector includes disposing a primary brazing slurry in contact with both the solid oxide fuel cell and the current collector. The method further includes heating the solid oxide fuel cell, the current collector, and the primary brazing slurry above a brazing temperature and subsequently cooling the solid oxide fuel cell, the current collector and the primary brazing slurry below the brazing temperature to form a solid oxide fuel cell primarily brazed to the current collector. The method further includes disposing a secondary brazing slurry to the solid oxide fuel cell primarily brazed to the current collector in a secondary brazing slurry application process. The method still further includes heating the solid oxide fuel cell primarily brazed to the current collector and the secondary brazing slurry above the brazing temperature and subsequently cooling the solid oxide fuel cell primarily brazed to the current collector and the secondary brazing slurry below the brazing temperature to form the solid oxide fuel cell secondarily brazed to the current collector.

Further, a solid oxide fuel cell includes an electrolyte, a first electrode, and a second electrode. The solid oxide fuel cell further includes a first electrode current collector secondarily brazed to the first electrode.

### DESCRIPTION OF THE FIGURES

FIG. 1 shows a prospective view of a tube member including a fuel cell tube and a fuel feed tube in accordance with an exemplary embodiment of the present disclosure;

FIG. 2 shows a cross-sectional view of a fuel cell tube primarily brazed to a current collector;

FIG. 3 shows a cross-sectional view of the fuel cell tube secondarily brazed to the current collector; and

FIG. 4 depicts a flow chart diagram of a method for forming a fuel cell tube brazed to a current collector in accordance with an exemplary embodiment of the present disclosure.

It should be understood that the appended drawings are not necessarily to scale, presenting a somewhat simplified representation of various preferred features illustrative of the basic principles of the invention. The specific design features of the fuel cell will be determined in part by the particular intended application and use environment. Certain features of the illustrated embodiments have been enlarged or distorted relative to others for visualization and understanding. In particular, thin features may be thickened for clarity of illustration. All references to direction and position, unless otherwise indicated, refer to the orientation of the fuel cell illustrated in the drawings.

### DETAILED DESCRIPTION

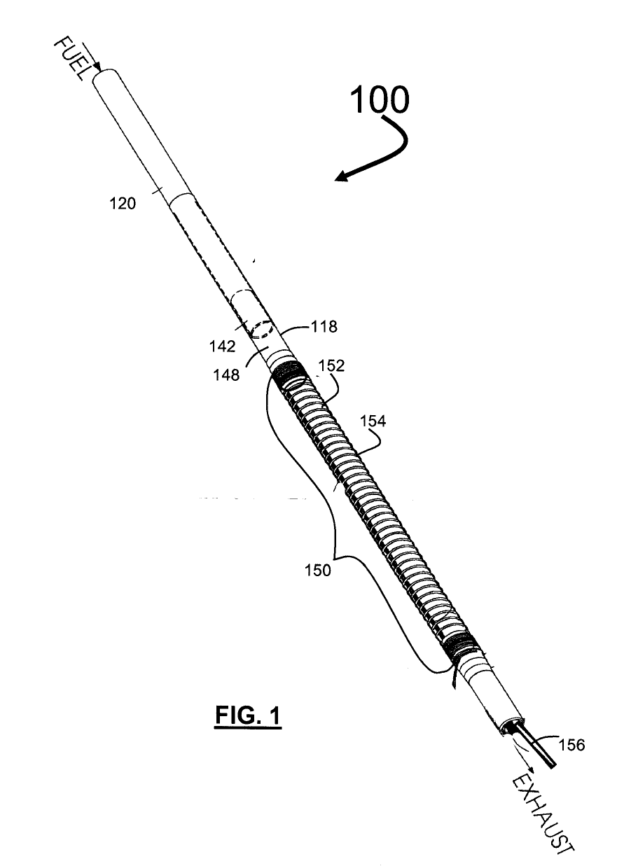

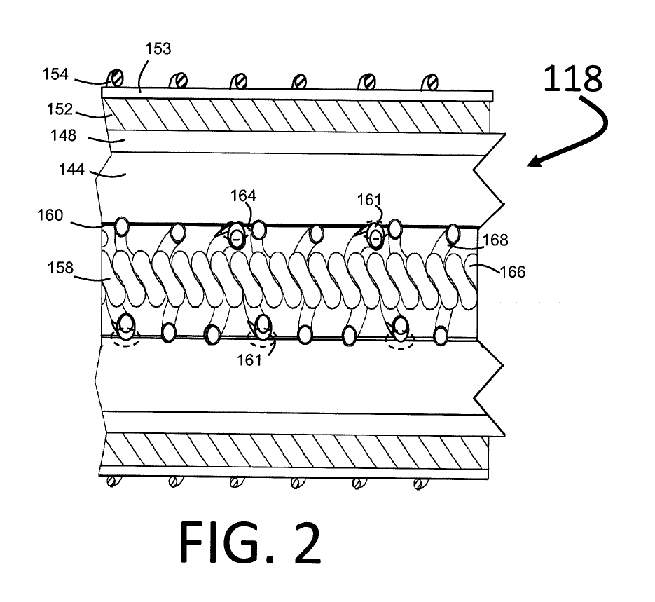

Referring to FIG. 1 and FIG. 2 a tube assembly 100 includes a fuel cell tube 118 and an anode current collector 158 that is secondarily brazed to the fuel cell tube 118. The tube assembly 100 further includes the fuel feed tube 120, a cathode current collector 152, and an anode current collector 158.

The fuel feed tube 120 has a fuel reforming reactor 142 disposed therein, and the fuel feed tube 120 is disposed within the fuel cell tube 118. The fuel cell tube 118 comprises an anode layer 144 and an electrolyte layer 148 disposed exteriorly to the anode layer 144 extending throughout the length of the fuel cell tube 118. The fuel cell tube 118 includes a cathode layer 152 disposed exteriorly from the electrolyte layer 154 at an active portion 150. The active portion 150 generates electricity at operating temperatures in the range of 700 to 850 degrees Celsius.

The exemplary fuel cell tube 118 is a solid oxide fuel cell that is advantageously relatively lightweight and can operate providing a high power density to mass ratio. As an example, the tube can be 1 mm-20 mm in diameter, and can be heated rapidly. An example of a suitable fuel cell tube is disclosed in U.S. Pat No. 6,749,799 to Crumm et al, and is hereby incorporated by reference. Other material combinations for the anode layer, the cathode layer, and the electrolyte layer as well as other cross-section geometries (triangular, square, polygonal, etc.) will be readily apparent to those skilled in the art given the benefit of the disclosure.

In general, the anode layer 144 and the cathode layer 154 are formed of porous materials capable of functioning as an electrical conductor and capable of facilitating the appropriate reactions. The porosity of these materials allows dual directional flow of gases (e.g., to admit the fuel or oxidant gases and permit exit of the byproduct gases). The anode layer 144 comprises an electrically conductive cermet that is chemically stable in a reducing environment. In an exemplary embodiment, the anode layer 144 comprises a conductive metal such as nickel, disposed within a ceramic skeleton, such as yttria-stabilized zirconia. The cathode layer 154 comprises a conductive material chemically stable in an oxidizing environment. In an exemplary embodiment, the cathode layer 154 comprises a perovskite material and specifically lanthanum strontium cobalt ferrite (LSCF). In an alternative exemplary embodiment, the cathode layer 154 comprises lanthanum strontium manganite (LSM).

The electrolyte layer 148 comprises a dense layer preventing molecular transport, therethrough. Exemplary materials for the electrolyte layer 148 include zirconium-based materials and cerium-based materials such as yttria-stabilized zirconia and gadolinium-doped ceria, and can further include various other dopants and modifiers to affect ion conducting properties. The anode layer 152 and the cathode layer 156, which form phase boundaries with the electrolyte layer 154, are disposed on opposite sides of the electrolyte layer 154 with respect to each other.

The a fuel feed tube 120 routes bulk fuel flow in a generally uniform direction past the fuel reforming reactor 142 such that substantially all the raw fuel is catalyzed within the fuel reforming reactor prior to contacting the anode layer 144 of the fuel cell tube 118.

The fuel cell tube 118 is coupled to a cathode current collector 154 through a cathode contact layer 153, both of which conducts current between the cathode layer 152 and other components of an electric circuit powered by the fuel cell tube 118. The exemplary cathode current collector 154 comprises a metallic wire disposed circumferentially around each fuel cell tube 118. The cathode current collector 154 can comprise, for example, fine gauge wire allowing flexibility to absorb energy when subjected to irregular stresses. Irregular stresses and shock loading can be expected with a portable, lightweight solid oxide fuel cell. An example of a suitable wire for use in such cathode current collector is 250 micron silver wire. In other embodiments, the wires of the cathode current collector 154 can comprise high temperature metals or metal alloys having oxidation resistance at 600 to 900° C. examples of which include platinum, palladium, gold, silver, iron, nickel and cobalt-based materials. Further, the cathode current collector 154 is electrically conductive (so that electrons generated as a result of the electrochemical reaction of the fuel cell tube 118 can be collected) and permeable to oxygen (so that oxygen can reach the active area and enter the electrochemical reaction).

In general, it is desirable to reduce ohmic loss and cathode overpotential at the cathode layer 152. In an exemplary embodiment, a contact layer 153 is disposed at an interface between the cathode current collector 154 and the cathode layer 152 that functions to reduce ohmic loss and cathode overpotential. In an exemplary embodiment, the contact layer 153 is applied as a layer about 10 to 40 microns thick prior to positioning the cathode current collector 154 around the cathode layer 152. In an exemplary embodiment, the contact layer 153 comprises gold. In an alternative embodiment, a contact layer disposed between the cathode and the cathode current collector can comprise perovskite.

The fuel cell tube 118 comprises an anode current collector 158 and an braze layer 160, both of which conduct current between the anode layer 144 and other components of an electric circuit powered by the fuel cell tube 118.

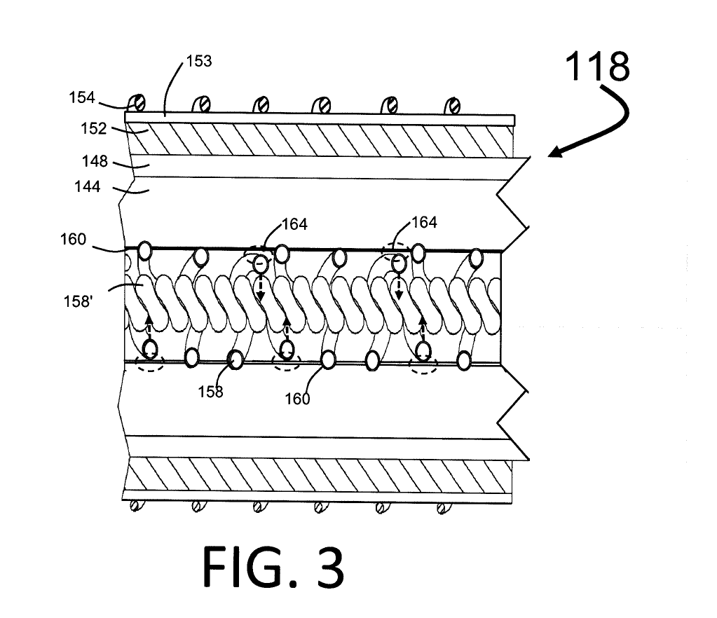

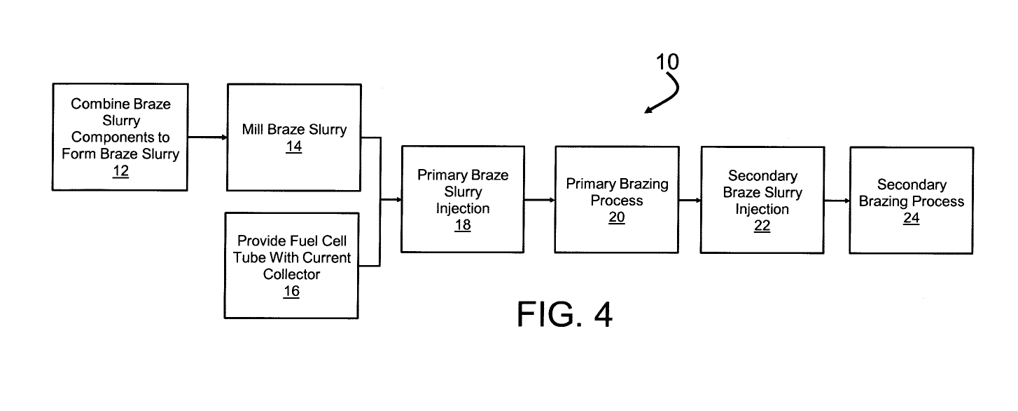

Referring to FIGS. 3 and 4, the anode current collector 158 comprises a wire brush having an inner core 166 and a plurality of loop members 168 extending therefrom. The inner core functions as an arterial electrical conduit providing current conduction the length of the current collector 158. The loop members 168 have resilient properties and overall diameter of the anode current collector 158 can be set such that the loop members 168 are compressed against an inner wall of the anode layer 144 proximate the active portion 150. Continuous lengths of compressed loop members 102 contact the anode layer 144 to promote electrical contact with the anode layer 144.

The loop members 168 route electrons relatively short distances between the anode layer 144 and the inner core 166. The loop members 144 have open space therebetween, allowing fuel to pass between the loop members 144. The anode current collector 158 comprises an electrically conductive metal. Since the wire brush member is positioned in the processed fuel gas, the anode current collector 158 is formed from material that maintains conductivity in the operating environment of an inner chamber of the fuel cell tube 118. Exemplary materials for the anode current collector include stainless steel, copper and copper alloys, and nickel and nickel alloys.

A braze layer 160 can physically and electrically connect the anode layer 144 to the anode current collector 158. The braze layer 160 can comprise metal materials, for example, metals that are electrically conductive in the high temperature operating environment of the inner chamber of the fuel cell tube 118. Further, the braze layer 160 can comprise material that have lower melting points and lower softening points than the anode current collector 158.

Referring to FIG. 4, a method for forming a fuel cell tube brazed to a current collector (10) includes combining braze slurry components to form braze slurry (12). The braze slurry components are precursor components of the braze layer 160. The braze slurry components include a metal oxide component, a binder component, and a solvent component. The metal component can include conductive metals, metal oxides that can be reduced to conductive metals, and ceramic components that can provide structural support. In an exemplary embodiment, the metal component includes an alloy comprising nickel along with one or more melting point reducing component. Exemplary melting point reducing components include copper and phosphorus. The nickel component of the braze layer 160, in the form of nickel oxide, tailors the braze layer 160 with electrical and thermal compatibility with the nickel oxide anode layer of the fuel cell tube.

Various conductive metal components can be in the form of metal oxide and then subsequently reduced while subsequently heating the components in a reducing atmosphere. In an exemplary embodiment, the braze slurry comprises copper powder and nickel oxide power and the nickel oxide powder is subsequently reduced to nickel when subsequently heating the slurry in a reducing atmosphere. In an exemplary embodiment, the slurry comprises between about 25 weight % and 75 weight % nickel oxide and between about 25 weight % and 75 weight % copper. The actual amounts of nickel oxide and copper can be adjusted to provide desired conductivity and durability properties.

The binder component can comprise subcomponents such as materials commonly referred to as binders and dispersants that can provide selected cohesive and rheological properties to provide desired coating of the anode current collector 158. Exemplary binder components include ethyl cellulose, polyethylene glycol, and polyester/polyamine copolymers.

The solvent components can comprise solvents generally compatible with the binder components to provide selected cohesive and rheological properties to the slurry. In an exemplary embodiment, the solvent components comprise organic solvents, and in particular comprise ethyl acetone and acetone. In alternate embodiments, the solvent component can comprise water or the solvent component can comprise one or more other organic solvents such as alcohols, glycols and the like.

At step 14, the braze slurry is milled to mix the brazed slurry to provide a selected distribution of particle sizes within the braze slurry. In an exemplary embodiment, the slurry is balled milled utilizing zirconia milling media for a time period of about 24 hours. In alternate embodiments, other milling processes can be utilized with or without the use of solvent. Exemplary milling processes include roll milling, attrition milling, jet milling and the like.

In an alternate embodiment, the slurry comprises nickel oxide and samarium-doped ceria along with an organic solvent and binder. Further, in alternate embodiments the braze slurry can include phosphorus or bismuth. Further, in an alternate embodiment, the contact layer can comprise and can comprise a paint containing copper oxide, which is applied to the wire or wires of the anode current collector 156 prior to insertion into the inner chamber of the fuel cell tube 118.

At step 16, the solid oxide fuel cell tube 118 is provided having an anode current collector 158 disposed therein. At step 16, the anode current collector 158 contacts the anode layer 144 such that the anode current collector 158 is pressed against the anode layer 144. In an exemplary embodiment, the solid oxide fuel cell 158 includes an anode contact layer, the anode layer 144, the electrolyte layer 148, and the cathode layer 152 at step 16. However, in alternate embodiments, the solid oxide fuel cell tube 118 can be provided without the cathode layer 152 and the cathode layer can be applied in a subsequent step. Further, the solid oxide fuel cell can include the cathode current collector 154 or the cathode current collector can be applied in a subsequent step.

At step 18, a primary braze slurry is injected into the fuel cell tube 118 to coat the anode current collector and the anode layer 144. The terms “primary,” “primarily,” “secondary,” and “secondarily” as used herein do not denote any order of importance, but simply designate a temporal order in applying the slurry. The injection step 18, can be followed by an air flowing step in which a positive or a negative pressure is applied across the cell and wherein excess slurry is permitted to exit the fuel cell tube, thereby providing coatings of substantially uniform thickness disposed on the braze layer 160 and the anode current collector 158.

At step 20, the solid oxide fuel cell tube 118 is brazed to the anode current collector 158 in a primary brazing process. During the primary brazing process, the solid oxide fuel cell tube 118, the current collector and the is heated to a temperature of above 750 degrees Celsius and to a primary brazing temperature between about 750 degrees Celsius and 900 degrees Celsius. The binder and the solvent are evaporated during the primary brazing process. Further, the exemplary primary process utilizes a reducing atmosphere, wherein the reducing atmosphere comprises about 5 mole percent hydrogen or more. The nickel oxide is reduced to nickel metal when the fuel during the primary brazing process.

The solid oxide fuel cell tube is brazed at the brazing temperature for about 1 hour and is subsequently cooled below 900 degrees Celsius and, in particular, the solid oxide fuel cell tube 118 is cooled to about room temperature, when the after thermal cycling, the anode current collector (generally depicted as 158′ in FIG. 3) deforms and contracts (thereby moving in directions shown by arrows in FIG. 3) and forms gaps 164 of poor electrical contact between the anode layer 144 and the anode current collector 158.

At step 22, a secondary braze slurry is injected into the fuel cell tube 118 to coat the anode current collector and the anode layer 144. Although in the secondary embodiment, the secondary braze slurry comprises the same material composition as the primary braze slurry, in alternate embodiments, the primary and secondary braze composition can differ in material composition. The injection step 22, can be followed by an air flowing step in which a positive or a negative pressure is applied across the cell and wherein excess slurry is permitted to exit the fuel cell tube, thereby providing coatings of substantially uniform thickness disposed. The secondary braze slurry can provide electrical bridges 161 spanning the gap 164, thereby providing electrical connectivity between the anode current collector 158 and the anode layer 144.

At step 24, secondary brazing the solid oxide fuel cell tube is brazed to the anode current collector 158 in a secondary brazing process. During the primary brazing process, the solid oxide fuel cell tube is heated to a temperature of above 900 degrees Celsius and to a primary brazing temperature between about 900 degrees Celsius and 1,100 degrees Celsius. Further, the exemplary primary process utilizes a reducing atmosphere, wherein the reducing atmosphere comprises about 5 mole percent hydrogen or more. By selecting the amount of slurry deposited within the fuel cell tube 118, the electrochemical properties of the fuel cell tube 118 along with the cross-sectional area of the fuel cell tube 118 can be controlled.

In alternate embodiments, the current collecting system can comprise an environmentally protective outer layer and an inner core. Further, the wire utilized for current collection systems such as the current collection system 70 can comprise any one of a variety of cross-sectional constructions. For a further description of interconnect system wire form factors refer to U.S. patent application Ser. No. 12/044,355 entitled CLAD COPPER WIRE HAVING ENVIRONMENTALLY ISOLATING ALLOY, which hereby incorporated by reference.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method for forming a solid oxide fuel cell tube coupled to a current collector, the method comprising:
providing a solid oxide fuel cell tube having an interior anode, an exterior cathode and an electrolyte;
inserting an anode current collector into an open end of the interior anode, the anode current collector being mechanically compliant and having a low resistance stein portion and a brush portion extending radially out from the stem portion, wherein the brush portion includes a plurality of wire loops radiating from the stem portion, each wire loop extending directly from the stem portion to a radially distal looped anode contact area;
disposing a brazing slurry in contact with both the interior anode portion of the solid oxide fuel cell tube and the looped anode contact areas of the anode current collector;
heating the solid oxide fuel cell tube, the anode current collector, and the brazing slurry above a brazing, temperature and subsequently cooling the solid oxide fuel cell tube, the anode current collector and the primary brazing shiny below the brazing temperature to form a brazed joint between the interior anode portion of the solid oxide fuel cell and the looped anode contact areas of the anode current collector.

2. The method of claim 1, comprising heating the solid oxide fuel cell tube and the primary brazing slurry to a temperature of between 750 and 900 degrees Celsius lower than the current collector.

3. The method of claim 1, comprising heating the solid oxide fuel cell tube and the brazing slurry to a temperature of between 700 and 1000 degrees Celsius.

4. The method of claim 1, wherein the brazing slurry comprises nickel and copper.

5. The method of claim 4, wherein the nickel comprises nickel oxide.

6. The method of claim 1, wherein the anode current collector comprises nickel and the brazing slurry comprises nickel and at least one of copper, boron and phosphorus.

7. (canceled)

8. The method of claim 1, wherein heating the solid oxide fuel cell tube and the brazing slurry above a brazing temperature comprising heating the solid oxide fuel cell tube in a reducing atmosphere.

9. The method of claim 1, wherein heating the solid oxide fuel cell tube and the brazing slurry above the brazing temperature and subsequently cooling the solid oxide fuel cell tube comprises cooling the solid oxide fuel cell tube to about room temperature.

10. The method of claim 1, wherein the anode current collector contracts when heating the solid oxide fuel cell tube and the brazing slurry above a brazing temperature and subsequently cooling the solid oxide fuel cell tube and the primary brazing slurry below the brazing temperature.

11. The method of claim 1, comprising disposing a brazing slurry in contact with both the solid oxide fuel cell tube and the anode current collector in the brazing slurry application process.

12. A method for forming a solid oxide fuel cell brazed to a current collector, the method comprising:
providing a solid oxide fuel cell tube having an interior anode, an exterior cathode and an electrolyte;
inserting an anode current collector into an open end of the interior anode, the anode current collector being mechanically compliant and having a low resistance stem portion and a brush portion extending radially out from the stem portion, wherein the brush portion includes a plurality of wire loops radiating from the stein portion, each wire loop extending directly from the stem portion to a radially distal looped anode contact area;
disposing a primary brazing slurry in contact with both the interior anode portion of the solid oxide fuel cell tube and the looped anode contact areas of the anode current collector;
heating the solid oxide fuel cell tube, the anode current collector, and the primary brazing shiny above a brazing temperature and subsequently cooling the solid oxide fuel cell tube, the anode current collector and the primary brazing slurry below the brazing temperature to form a brazed joint between the interior anode portion of the solid oxide fuel cell and the looped anode contact areas of the anode current collector disposing a secondary brazing slurry to the solid oxide fuel cell primarily brazed to the anode current collector in a secondary brazing slurry application process; and
heating the solid oxide fuel cell primarily brazed to the anode current collector and the secondary brazing slurry above the brazing temperature and subsequently cooling the solid oxide fuel cell primarily brazed to the anode current collector and the secondary brazing slurry below the brazing temperature to form the solid oxide fuel cell secondarily brazed to the anode current collector.

13. The method of claim 12, comprising heating the solid oxide fuel cell tube and the primary brazing slurry to a temperature of between 900 and 1,100 degrees Celsius.

14. The method of claim 12, wherein the primary brazing slurry comprises nickel and copper.

15. The method of claim 12, comprising disposing a primary brazing slurry in contact with both the solid oxide fuel cell tube and the anode current collector in the primary brazing slurry application process.

16. The method of claim 12, wherein heating the solid oxide fuel cell tube and the primary brazing slurry above a brazing temperature comprising heating the solid oxide fuel cell tube in a reducing atmosphere.

17. A solid oxide fuel cell comprising:
an electrolyte, a first electrode, and a second electrode and a first electrode current collector secondarily brazed to the first electrode.

18. The solid oxide fuel cell of claim 17 comprising a solid oxide fuel. cell tube comprising an inner electrode and an outer electrode, wherein the first electrode current collector is secondarily brazed to the inner electrode of the solid oxide fuel cell tube.

19. The solid oxide fuel cell of claim 17, wherein the current collector is secondarily brazed to the first anode utilizing a braze material comprising, nickel and copper.

20. The solid oxide fuel cell of claim 17, wherein the current collector comprises nickel.
